(19) United States
(12) Patent Application Publication
(10) Pub. No.: US 2014/0062188 A1
(43) Pub. Date: Mar. 6, 2014

(54) Solar Retrofit Pole

(71) Applicant: Wing Power Energy, Inc., Burlington, MA (US)

(72) Inventor: Kahoru Watanabe, Sarasota, FL (US)

(21) Appl. No.: 14/016,002

(22) Filed: Aug. 30, 2013

Related U.S. Application Data
(60) Provisional application No. 61/695,339, filed on Aug. 31, 2012.

(51) Int. Cl. F21S 9/03

(52) U.S. Cl. CPC F21S 9/035
USPC 307/18; 362/183; 29/825

(57) ABSTRACT

A utility pole kit efficiently retrofits existing street and parking light systems and other utility poles to allow replacement of such system with more efficient lighting and power sources. Existing foundations of older light poles are used, and the poles are replaced with new solar powered poles that are self-raising and are fully self-contained, including batteries used for storing power.

### CROSS-REFERENCE TO RELATED APPLICATIONS

This application is a nonprovisional application of provisional patent application 61/695,339, filed Aug. 31, 2012, entitled “Solar Retrofit Pole,” which is hereby incorporated by reference.

### BACKGROUND

The present invention relates to utility poles, and more specifically to a solar retrofit pole.

The energy crisis caused a considerable growth of interest in alternative energy solutions in the past few years. The aging urban infrastructure and the use of energy inefficient lights are among the issues that the private and public sectors alike are trying to address. The costs associated with powering older lighting technologies and the maintenance costs associated with keeping them operational are among the problems that need to be addressed, as governments have less available funds and yet need to address these problems. LED lighting has a near 30 year life, versus 3 to 5 years for traditional lights, while solar is a virtually unlimited free power resource.

### SUMMARY

This Summary introduces selected concepts in simplified form that are further described below in the Detailed Description. This Summary is intended neither to identify key or essential features of the claimed subject matter, nor to limit the scope of the claimed subject matter.

The present invention relates to solar lighting, utility and power related solutions and methods for efficiently retrofitting existing street/parking light systems and other utility poles. More specifically, the system and method of the present invention are directed to utilizing the existing foundations of older light poles and replacing them with new solar powered poles that are self-raising and are fully self-contained, including batteries used for storing power. The present invention addresses ease of installation, the high costs associated with replacements or upgrades, while solving the primary issues related to the housing of the batteries required for this type of system.

### DESCRIPTION OF THE DRAWINGS

FIGS. 1A-1D show exemplary universal foundation attachment designs.

FIGS. 2A-2B illustrate a side view (2A) and top view (2B) of a pole prior to being erected.

FIGS. 3A-3D illustrate a pole being raised using a hydraulic arm.

FIGS. 4A-4C illustrate solar lights with the solar panels at different heights along a pole as well as different number of lights on the pole.

FIG. 5 illustrates various options for the locations for the battery.

FIGS. 6A-6B illustrate a fully erected utility pole, with the removal of installation flanges and the placement of the interior access panels.

FIG. 7 illustrates the operational system of the present invention in its installed final state, the components and how they operate.

### DETAILED DESCRIPTION

Reference will now be made in detail to embodiments, examples of which are illustrated in the accompanying drawings. In the following detailed description, numerous specific details are set forth in order to provide a thorough understanding of the invention. However, it will be apparent to one skilled in the art that the invention may be practiced without these specific details. In other instances, well-known methods, procedures, components, circuits, and networks have not been described in detail so as not to unnecessarily obscure aspects of the embodiments.

The present invention adapts existing infrastructure, such as utility and light fixture poles, streamlines an installation process and solves battery placement land use issues. The present invention enables a more cost effective retrofitting that will save governments and private sector money, while reducing overall power consumption.

Currently the most common conversion towards LED lighting is occurring in new construction or when the poles need to be replaced due to structural aging. In cases where it is possible to simply plug in LED light bulbs, those opportunities are being maximized, but in many cases this alone is not a viable solution, especially where infrastructure is aging or approaching the end of its useful life.

The process of maintaining and changing light bulbs with 3 to 5 year shelf lives is a costly one. A light emitting diode (LED) lasts approximately 6 to 10 times longer than a standard bulb and reduces power for equivalent light coverage. Currently, most of these solutions still have a need for grid tied power and require heavy equipment to elevate workers high enough to change the dead or dying bulbs. A reason for resisting solar solutions is that until now battery storage has been a major hindrance in terms of the space required and complicated housing or simple logistical challenges, such as parking lots with no space. Prior to the current invention, the battery storage solutions included: underground burial, which is often not possible and requires disturbing existing infrastructure, such as pavement or sidewalk; attaching a battery box outside the tower, which would lead to theft and is visually not appealing; or using an electrical box housing that is both very expensive and space consuming.

The present invention provides a system that can be installed in new sites, but is capable of being modified to attach to existing older foundations to minimize construction disturbance through digging or trenching for wires. The present invention lowers installations costs by eliminating the need for cranes during installation and by allowing ground-based assembly. By recycling existing foundation anchors, the present invention dramatically reduces overall costs in material, labor and machinery.

By housing the batteries anywhere within an inside cavity of a pole, the batteries are safer from theft, eliminate the need to dig potentially costly holes or take up space using costly secure electrical boxes at the base of the pole. The number, type and configurations of the batteries, and battery capacity, are selected to achieve an amount of backup time appropriate to the installation.

In the present invention, a use of hydraulic lifts to raise the tower simplifies the installation process, eliminating the need for cranes of bucket lifts to put the system together. The system of the present invention is completely put together on the ground, which saves time, the batteries placed within its base and raised in one piece. In hurricane, typhoon or cyclone prone areas, with ample time for warning, the poles can be taken down using the hydraulic system of the present invention and solar panels can be removed to avoid damage.

In addition, the present invention uses LED lights, which reduce the cost of maintenance on the lights, replacement cost of the lights, while reducing electricity expenses.

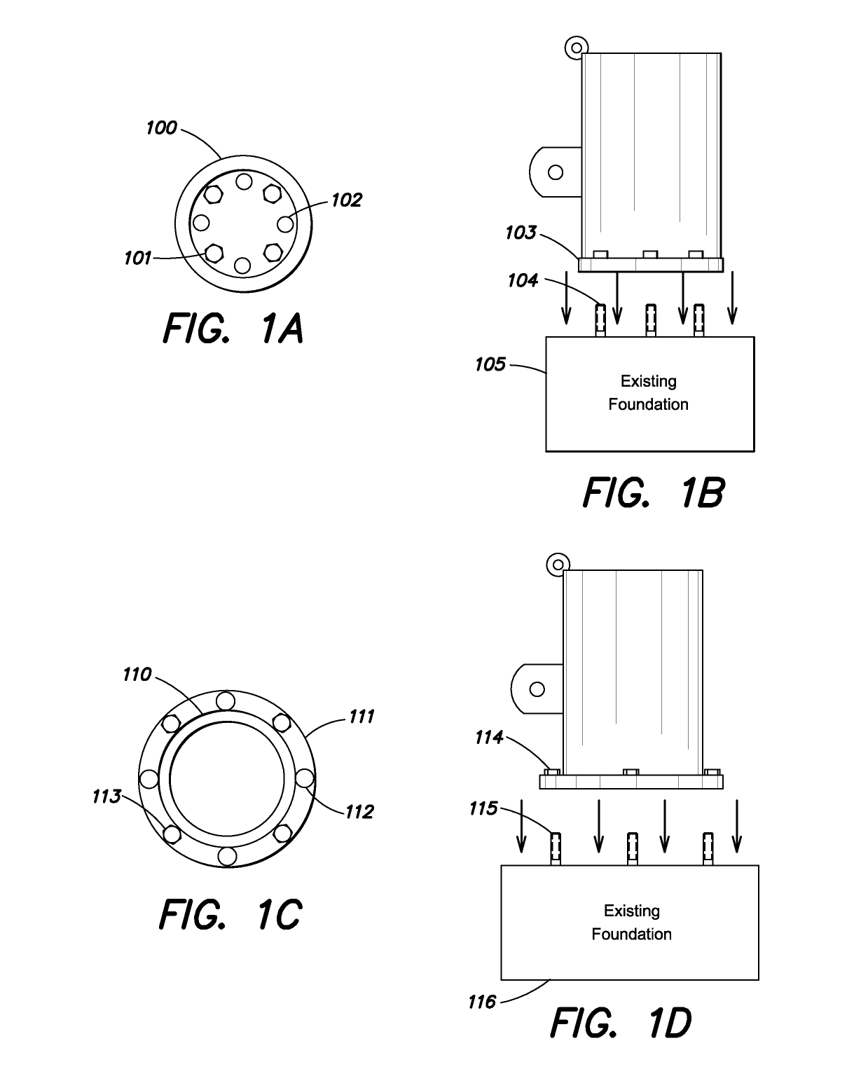

Referring now to the figures, FIGS. 1A-1D show design concepts that enable the present invention to be easily adapted to an existing light pole or other utility foundations.

FIGS. 1A-1B show a base being attached from the inside of a cavity of a pole. The top view shows the outside wall of the pole, 100, and within the cavity a bottom plate, 102, 103 is attached that bolts 101 onto the anchors 104 of the existing foundation 105. The bottom plates, 102, 103 are designed to be easily customizable to match the anchor bolt pattern of any existing foundation 105 before installation.

FIGS. 1C-1D show the base being attached to the existing anchors, 115, and bolted, 113 from the outside of the pole, 114. In this example, a plate 111 extends beyond the outside walls of the pole, 110 and, as with FIGS. 1A-1B, the holes 112 can be custom drilled to match virtually any anchor placement on the existing foundation 116.

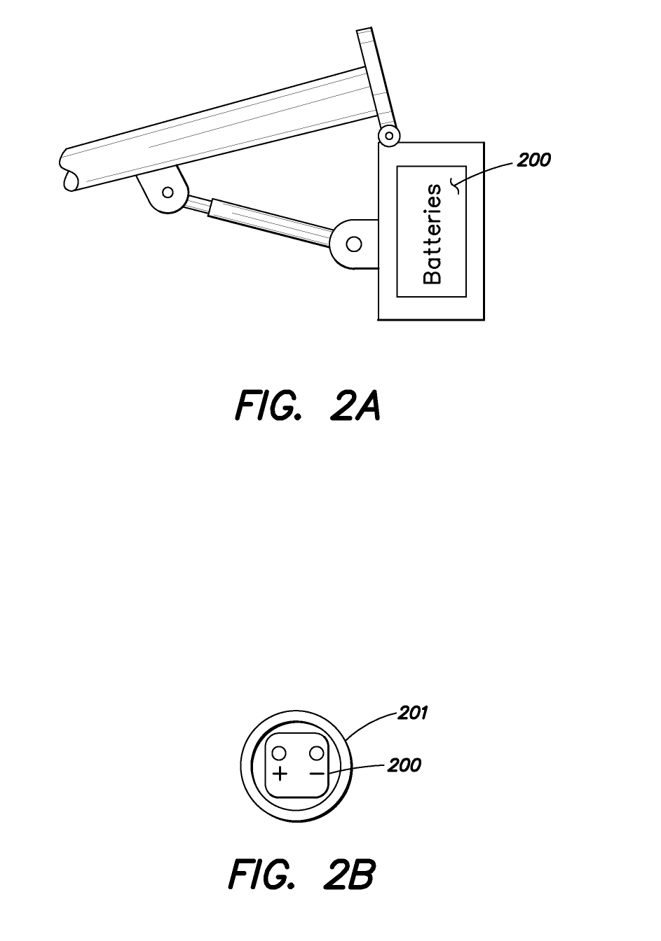

FIGS. 2A-2B show the pole prior to being erected upright. The battery, 200, is housed within the cavity of the base section of the pole, 201. The placement of batteries is not limited to the base of the pole and can be accommodated along the length of the cavity of the pole. The battery or multiple batteries may or may not be connected in series and the wires lead to solar panels. An example commercially available battery is the Deka Solar MK 8A31DT AGM 106 Ah batteries. NiMH batteries are another option, particularly for installations in which the batter is mounted directly below the solar panel. The light sensing, timer or solar triggered charge controller activates the LED light or other electronically powered device by activating the batteries.

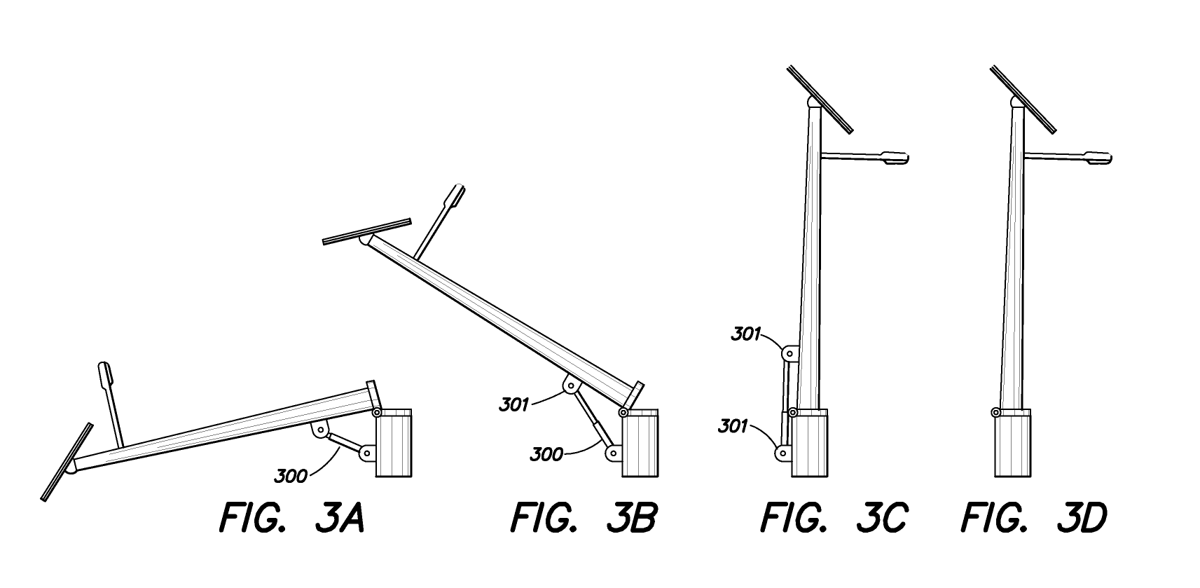

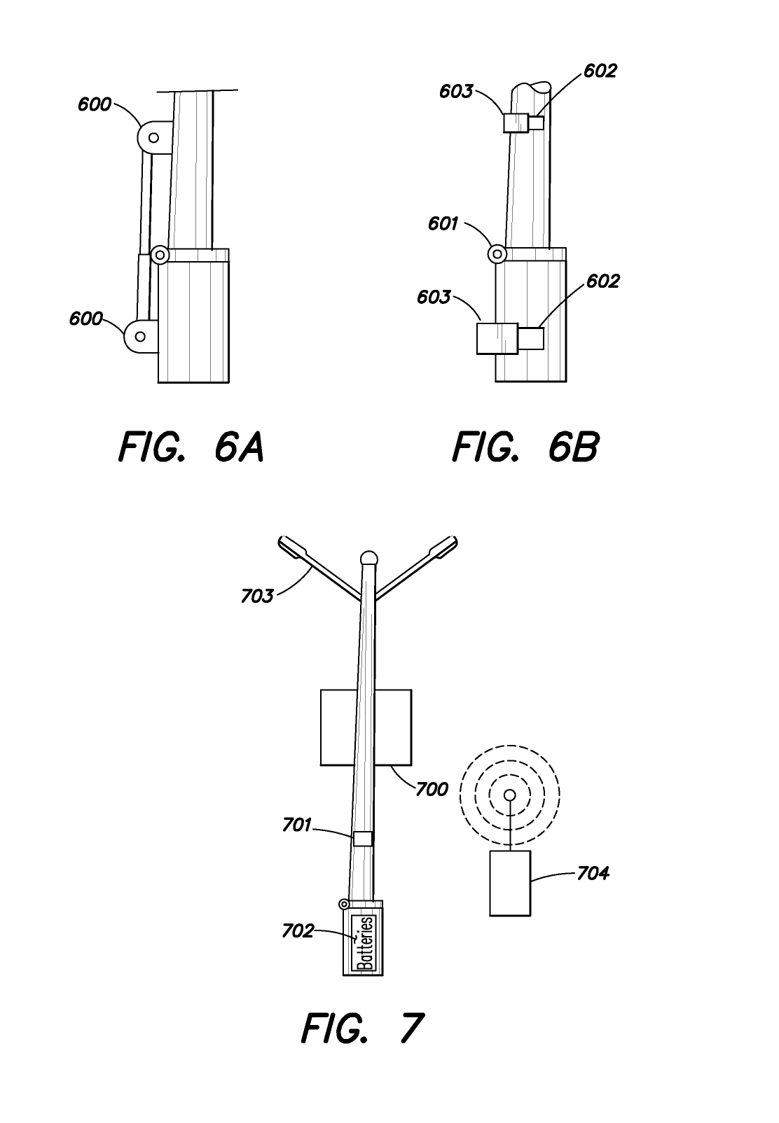

FIG. 3A illustrates a hydraulic arm, 300 attached to the flanges, 301, which are then attached to the pole base and upper section. The upper section may include one or multiple extensions. Once the solar panels, charge controllers and the light fixture and LED are fully installed on the ground, the system is raised (FIG. 3B) in its entirety. Once fully erected (FIG. 3C) and the bolts secured, the hydraulic arm, 300, is removed (FIG. 3D), which is followed by the flanges. The removal of the flanges is for aesthetic purposes, but the panels of FIG. 6 serve a multiple purpose to access components housed within the cavity of the pole, such as the wires, the charger controller or the batteries.

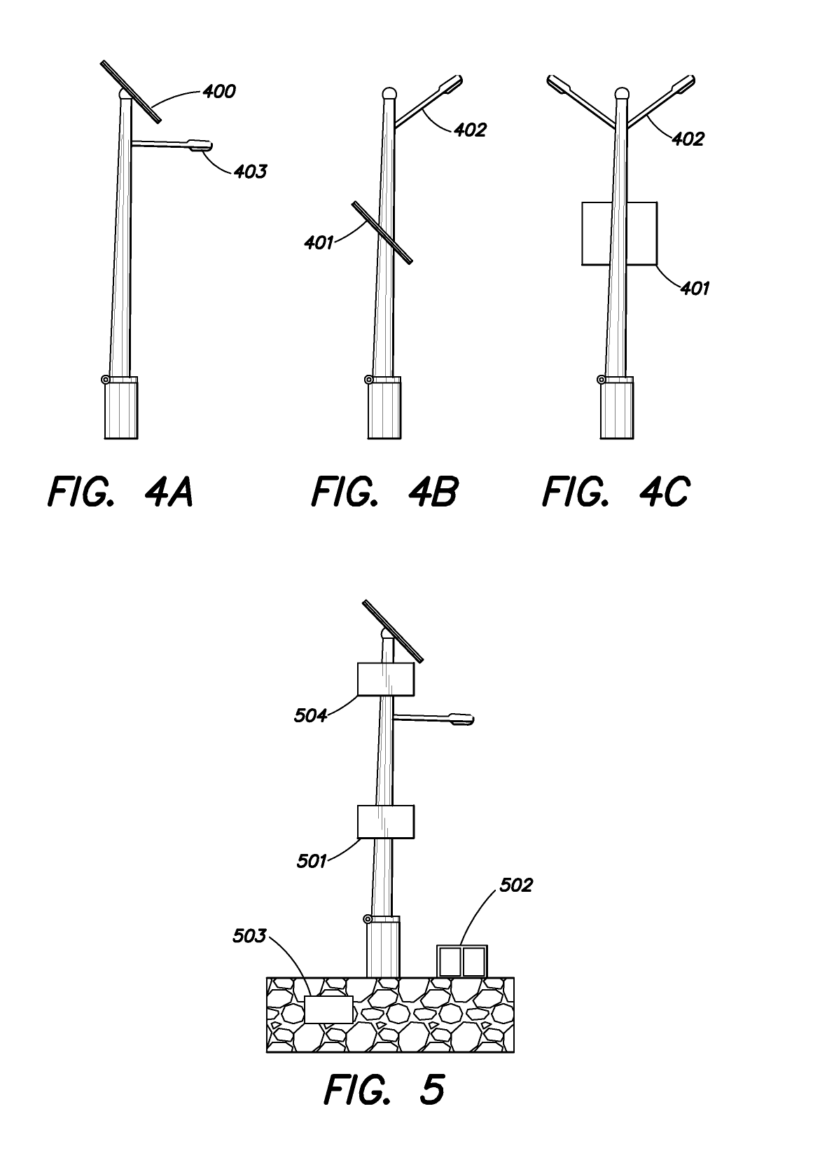

FIGS. 4A-4C show exemplary configurations of a lighting application for the positioning of solar panel(s) 400, 401 and lighting 402, 403. There may be a number of panels depending upon the power needs of the LED lights, storage or any other device the system is powering. In FIGS. 4B and 4C the solar panel 401 is shown near the middle of the pole, to show that the solar panels can be anywhere along the horizontal length of the pole. There is little limitation on the number of light fixtures 402, 403 or power devices 400, 401 that can be attached to the pole. The power production is adjusted by increasing or decreasing the number of solar panels used and thus the storage capacity within the system.

In FIG. 5, an exemplary solar pole is shown with the battery attached to the outside of the pole, 501, an electrical box located adjacent to the tower, 502 and the battery buried underground, 503, and a box 504 attached near the top of the pole. These clearly show the limitations of the current methods of battery storage that have been addressed by this solution.

FIGS. 6A-B depict the system of the present invention once erected and bolted into place, the flanges, 600, are removed revealing openings in the pole, 602 that can be used to access the interior of the unit for routine testing or inspection. The only piece that remains is the hinge, 601, which attaches the main pole to the base. The openings to the pole are then replaced by matching panels, 603, that are secured to minimize access and sealed to protect from the elements.

FIG. 7 illustrates the operation of the system of the present invention. The power for the operation of the system begins with the solar panels, 700, which produce power that is processed through the charger controller, 701, which then transfers the power for storage into the batteries, 702. The light, 703, is then triggered by the charger controller, 701, either by the solar panels, timer mechanism or light sensor. The controller may also be programmed using a remote wireless device, 704.

In one embodiment, one or more portions of the system according to the present invention may be coated to help clean and circulate the air around the pole. The treated area can act as a catalyst to break down organic pollutants on its surface and in the air around it in the presence of sunlight. Once broken down, rainwater simply rinses pollutants away. Any coating that is sintered or fixed into a glaze which in combination with light and water creates a self-cleaning effect may be used. An example of such coating is the HYDROTECT coating manufactured by TOTO, Ltd., of Kitakyushu, Japan. Coating surfaces with a hydrophilic titanium-dioxide material like the HYDROTECT coating allows for direct and environmental grime to be washed away with a simple rain water or moisture. When the HYDROTECT coating is used on building facades, rain water performs the rinse, lessening the need for polluting detergents, maintenance cleaning and reducing the waste of potable water for cleaning. The HYDROTECT coating may help to successfully reduce air pollution. The chemical reaction on the surface of treated areas removes Nitrous and Sulfuric Oxides from the air, both of which are categorized as a carbon emission by the Environmental Protection Agency (EPA). A 10,000 square-foot area treated with the HYDROTECT coating reduces the same amount of air pollution as 70 medium-size deciduous trees. The use of this type of treatment, or similar treatment, on the solar panels can increase its effectiveness, as a cleaner surface will produce more power than one covered with dirt and/or other particles.

In another embodiment of the invention, the tower that is universally retrofitted onto existing tower or pole foundations can be used as “hot spot” poles, security poles, and wireless integration of all uses.

Since the number of solar panels attached to the system of the present invention is limited only by the size of the tower and the power needs of the devices being installed, there are few applications that require power that cannot be accommodated. A primary advantage of is the ability to reduce costs, while minimizing construction disruption, time of install & maintenance and improved aesthetics.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A utility pole kit comprising:
a base having an inside cavity;
a pole;
a hinge connecting the base and the pole;
a battery adapted to be placed in the battery compartment;
a power generation source adapted to be connected to the pole and adapted to be electrically connected within the pole and base to charge the battery in the battery compartment when connected;
a system being powered adapted to be connected to the pole and adapted to be electrically connected within the pole and base to receive power from the battery in the battery compartment when connected; and
a hydraulic arm that, when connected to the base and the pole, is adapted to move the pole about the hinge with respect to the base between an upright position and a position on the ground.

2. The utility pole kit of claim 1 wherein the power generation source includes one or more solar panels.

3. The utility pole kit of claim 1 wherein the system being powered comprises one or more light fixtures.

4. The utility pole kit of claim 3 wherein the light fixture is a light emitting diode.

5. The utility pole kit of claim 1, wherein at least the pole is coated with a hydrophilic self-cleaning coating.

6. The utility pole kit of claim 1, wherein the coating is a hydrophilic titanium dioxide coating.

7. The utility pole kit of claim 1, wherein the system being powered comprises one or more wireless communication devices.

8. The utility pole kit of claim 1, further comprising a charger controller housed in the pole that transfers power generated by the power generation system to the battery.

9. A process for installing a utility pole, comprising:
installing a base on a foundation, the base having an inside cavity;
installing one or more batteries in the inside cavity of the base;
while a pole is on ground,
connecting one or more power generation sources to the pole;
connecting one or more systems to be powered to the pole;
electrically connecting the one or more power generation sources and the one or more systems to be powered to the one or more batteries in the base;
connecting a pole and the base to a hinge;
connecting a hydraulic arm to the pole and to the base;
using the hydraulic arm, lifting the pole so that the pole is positioned upright on top of the base;
securing the pole to the base; and
removing the hydraulic arm from the pole and the base.

10. The process of claim 9, wherein the hydraulic arm is connected to the pole and base through flanges attached to the pole and base, and the process further comprises removing the flanges.

11. The process of claim 10, further comprising replacing the flanges with access panels.
